(19) United States
(12) Patent Application Publication
(10) Pub. No.: US 2003/0194202 A1
(43) Pub. Date: Oct. 16, 2003

(54) Combination system and operation control method for controlling each of a plurality of devices through a single on-screen display

(76) Inventor: Eun-Jung Kang, Suwon-City (KR)

Correspondence Address: Stacey J. Longanecker, Roylance, Abrams, Berdo & Goodman, L.L.P., Suite 600, 1300 19th Street, N.W., Washington, DC, 20036, US

(21) Appl. No.: 10/401,843

(22) Filed: Mar. 31, 2003

(30) Foreign Application Priority Data
Apr. 15, 2002 (KR) 2002-20309

(51) Int. Cl. H04N 5/781

(52) U.S. Cl. 386/46; 386/125

(57) ABSTRACT

A combination system is constructed with a DVD device and a VCR device, and the DVD device has an OSD block. The OSD block of the DVD device produces an OSD, and the VCR device receives an operation command that a user inputs after looking up the OSD. The VCR device transfers the received operation command to the DVD device. The DVD device interprets the transferred operation command, performs a corresponding operation if the operation command is related to the DVD device, and transfers the operation command to the VCR device for a corresponding operation if the operation command is related to the VCR device. Accordingly, a user can conveniently manipulate the DVD device and the VCR device by using a single OSD.

This application claims benefit under 35 U.S.C. § 119 from Korean Patent Application No.2002-20309, filed on Apr. 15, 2002, the entire content of which is incorporated herein by reference.

### BACKGROUND OF THE INVENTION

1. Field of the Invention

The present invention relates to a combination system and an operation control method thereof, and more particularly to a combination system that combines plural devices for performing independent functions such as a DVDP (Digital Video Disk Player), VCR, and the like into one system, and an operation control method therefor.

2. Description of the Related Art

A system combining two or more different electronic devices into one is typically referred to as a ‘combination system’, a ‘combo-system’ or, more briefly, a ‘combo’. For example, a DVDP/VCR combo-system exists that performs DVD player and VCR functions in combination.

FIG. 1 is a schematic block diagram showing such an exemplary conventional DVDP/VCR combo-system and peripheral devices coupled thereto. The DVDP/VCR combo-system 100 is provided with a DVD device 102 for performing basic DVD player functions such as reproducing images and sounds recorded on a DVD, and a VCR device 104 for performing basic VCR functions such as reproducing images and sounds recorded on a magnetic tape and recording a signal from an external source onto magnetic tape.

A TV set 140 or the like can be coupled to the DVDP/VCR combo-system 100 as peripheral devices for outputting images and sounds reproduced from the DVD device 102 or the VCR device 104. An audio amplifier 130 and the like can also be coupled to the DVDP/VCR combo-system 100 as peripheral devices for outputting sounds reproduced from the DVD device 102. Further, an external device 150 such as a camcorder and the like can be coupled to the DVDP/VCR combo-system 100 The DVDP/VCR combo-system 100 inputs images and sounds from such an external device 150 to perform the above-described functions such as recording, reproducing recorded images and sounds, and the like.

The DVD device 102 and the VCR device 104 in the DVDP/VCR combo-system 100 exist in one system in appearance. A user can manipulate a separate input device such as a remote controller 120 and the like, a key input pad (not shown) provided on the front of the DVDP/VCR combo-system 100, or the like, to switch operation modes between the DVD device 102 and the VCR device 104, as well as control individual functions for each of the DVD device 102 and the VCR device 104.

In general, the combination system 100 described above has an OSD (On-screen Display) block (not shown) for providing a user with a choice menu through an OSD function. If a user first selects an OSD function to input a command through manipulation of the remote controller 120, a list of operation commands that can be inputted by the user is displayed on the screen of the TV set 140 or the like. The user can easily control operations he or she intends to manipulate through such a list. Such an operation command list contains commands for the environments of the DVD device 102 or the VCR device 104 (e.g., commands such as a setting command for selecting a language to be captioned onscreen).

However, the conventional combination system 100 has a separate OSD function for each of the DVD device 102 and the VCR device 104, which a user may find inconvenient and which may cause confusion. In other words, since an OSD for the DVD device 102 and an OSD for the VCR device 104 exist separately, a user has to use the OSD provided by the VCR device 104 to control the operations of the VCR device 104 through an OSD function via manipulation of the remote controller 120. Further, a user has to use the OSD provided by the DVD device 102 to control the operations of the DVD device 102. Therefore, in order to control the operation of the VCR device 104 or change the environment settings of the VCR device 104, a user has to first perform an operation to switch the operation mode of the combination system 100 from the DVD mode to the VCR mode.

Accordingly, when a user intends to input operations or environment settings shared in the DVD device 102 and the VCR device 104 such as the input of a command for performing a reproduction operation, setting a language to be used when reproduced, or the like, the user is prone to making mistakes when inputting operation commands due to inadvertently overlooking the current operation mode.

Further, the OSD for the DVD device 102 and the OSD for the VCR device 104 are configured in a non-harmonious fashion, rather than in a consistent fashion, with respect to each other, causing a problem that may lower the grade of the products.

### SUMMARY OF THE INVENTION

The embodiment of the present invention described herein overcome the above-mentioned problems associated with conventional combo-systems. Accordingly, it is an object of the present invention to provide a combination system having one incorporated on-screen display (OSD) and an operation method therefor that can obviate the inconvenience and confusion caused when manipulating a remote controller in response to respective on-screen displays for corresponding internal individual devices.

In accordance with an embodiment of the present invention, a combination system is provided which comprises (1) plural devices for performing independent functions based on an operation command provided thereto; (2) an OSD block for generating an OSD screen that provides a list of operation commands that can be inputted to perform various operations with each of the plural devices; and a controller for receiving, interpreting, and transferring an operation command that a user inputs with a look-up of the OSD screen to any one of the plural devices to perform the operation command.

The controller comprises an input controller for receiving an operation command; a command controller for interpreting and transferring the operation command that the input controller receives to any one of the plural devices to perform the operation command; and a communication device for enabling communications between the input controller and the command controller and between the command controller and the plural devices.

The plural devices preferably include a DVD player for reproducing a signal recorded on a DVD, and a VCR for recording/reproducing a signal to and from a magnetic tape. In accordance with an embodiment of the present invention, the DVD player comprises the OSD block and the command controller, and the VCR comprises the input controller.

In accordance with the present invention, a method is also provided for controlling the operations of a combination system that has plural devices for performing independent functions based on operation commands inputted. The method comprises steps of (a) generating an OSD display screen to display a list of operation commands that can be inputted for operations for each of the plural devices; (b) receiving an operation command that a user inputs with a look-up of the OSD display screen; and (c) interpreting and transferring the received operation command to any one of the plural devices to perform the operation command.

Preferably, the plural devices include a DVD player for reproducing a signal recorded on a DVD, and a VCR for recording/reproducing a signal to and from a magnetic tape, and the steps (a) and (c) are performed by the DVD player, and the step (b) is performed by the VCR.

Therefore, a user can control all the operations of the VCR and the DVD player through a single OSD display.

### BRIEF DESCRIPTION OF THE DRAWINGS

The above object and other features of the present invention will become more apparent by describing in detail a preferred embodiments thereof with reference to the attached drawings, in which:

FIG. 1 is a schematic block diagram for showing a conventional DVDP/VCR combination system;

FIG. 2 is a schematic block diagram for showing a DVDP/VCR combination system according to an embodiment of the present invention;

FIG. 3 is a flow chart for showing an operation control process to be carried out in the combination system shown in FIG. 2 according to an embodiment of the present invention;

FIG. 4 is a view for showing an illustration of a menu display provided by an OSD device in the combination system shown in FIG. 2 according to an embodiment of the present invention; and

FIG. 5 is a view for showing another illustration of a menu display provided by an OSD device in the combination system shown in FIG. 2 according to an embodiment of the present invention.

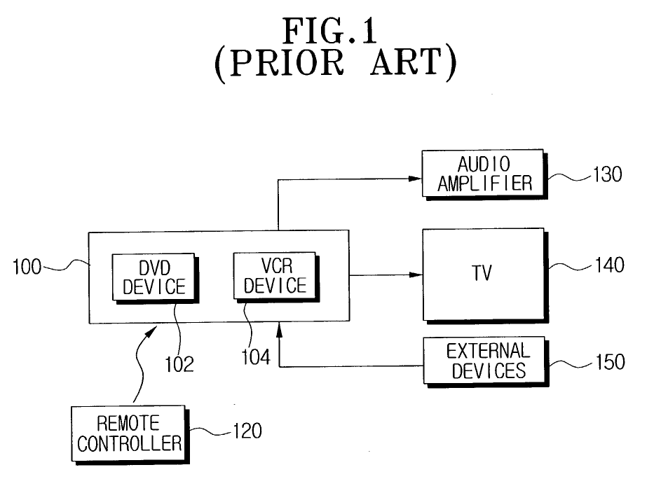

### DETAILED DESCRIPTION OF THE PREFERRED EMBODIMENTS

Hereinafter, the present invention will be described in more detail with reference to the accompanying drawings.

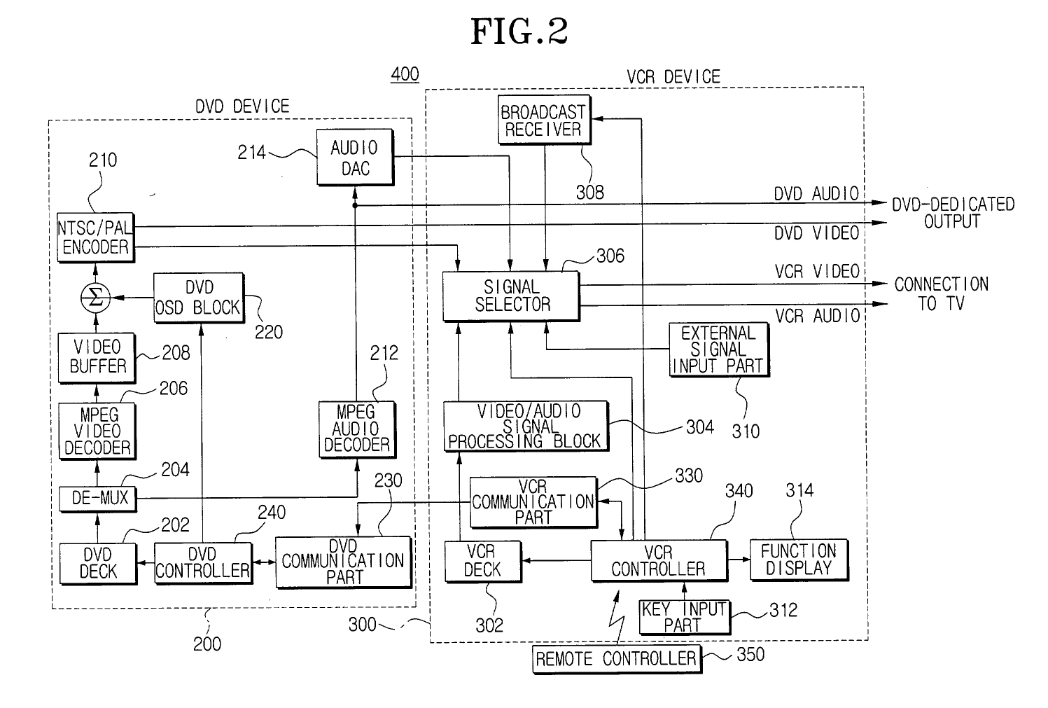

FIG. 2 is a block diagram for showing components constituents of a combo-system, particularly, a DVDP/VCR combo-system 400 capable of performing the functions of a DVD player and a VCR.

The DVDP/VCR combo-system 400 has a DVD device 200 performing the functions of a general DVD player, and a VCR device 300 performing the function of a general VCR.

The DVD device 200 comprises a DVD deck 202, DE-MUX 204, MPEG video decoder 206, VIDEO buffer 208, NTSC/PAL encoder 210, MPEG audio decoder 212, audio DAC 214, DVD OSD block 220, DVD controller 240, and a DVD communication part 230.

The DVD deck 202 operates to read in data recorded on a DVD in order to perform a reproduction operation for the DVD. The DE-MUX 204 classifies the data read in from the DVD deck 202 into a moving picture experts group (MPEG) video signal and an MPEG audio signal, and transfers the signals to the MPEG video decoder 206 and the MPEG audio decoder 212 respectively. The MPEG video decoder 206 decodes an MPEG-encoded video signal, and the MPEG audio decoder 212 decodes an MPEG-encoded audio signal. The VIDEO buffer 208 temporarily stores the decoded video signal.

The NTSC/PAL encoder 210 receives data from the VIDEO buffer 208 and the DVD OSD block 220 and outputs a DVD video signal in the NTSC (National Television System Committee) mode or in the PAL (Phase Alternation Line) mode. The audio DAC 214 receives data from the MPEG audio decoder 212 and outputs DVD audio data. The DVD video signal from the NTSC/PAL encoder 210 and the DVD audio signal from the audio DAC 214 are provided as DVD-dedicated output signals.

The DVD OSD block 220 generates an on-screen display which is in addition to the display reproduced by the DVD device 200. The DVD controller 240 controls the overall operations of the individual components in the DVD device 200. The DVD communication part 230 is used for communications between the DVD device 200 and the VCR device 300.

With continued reference to FIG. 2, the VCR device 300 comprises a VCR deck 302, video/audio signal processing block 304, signal selector 306, broadcast receiver 308, external signal input part 310, key input part 312, FUNCTION display 314, VCR communication part 330, and a VCR controller 340.

The VCR deck 302 records a signal on a magnetic tape or reproduces a signal recorded on the magnetic tape, and the video/audio signal processing block 304 receives and transfers the video and audio signals to be recorded or reproduced using the VCR deck 302.

The signal selector 306 receives as inputs the following: an output of the NTSC/PAL encoder 210, an output of the audio DAC 214, an output of the video/audio signal processing block 304, signals from the broadcast receiver 308 and the external signal input part 310, and so on. The signal selector 306 selects, from these inputted signals, a signal to be transferred to a TV set or the like based on the controls of the VCR controller 340. The selected signal is then provided as the VCR video and audio signals.

The broadcast receiver 308 tunes to a broadcast channel of a TV set or the like to receive a desired broadcast channel. The external signal input part 310 transfers a signal inputted from an external device to the signal selector 306. Signal output ports of an external device such as a camcorder or the like are connected to the external signal input part 310. Accordingly, a signal recorded on an external device can be transferred to the combo-system 400 through the external signal input part 306, as well as recorded on a magnetic tape via the VCR device 300, and/or reproduced through a TV set.

The VCR device 300 has a FUNCTION display 314 for displaying information such as operation states, operation modes, and the like and thereby allowing a user to view the information. The VCR device 300 also has a key input part 312 for inputting various commands from a user. The VCR controller 340 can input diverse operation commands from a user through the key input part 312 and a remote controller 350. Thus, the VCR controller 340 operates as an input controller, as well as controls the overall operations of the respective components of the VCR device 300.

The VCR controller 340 and the DVD controller 240 are connected to each other through the VCR communication part 330 and the DVD communication part 230 to mutually receive and transfer commands. Therefore, a command inputted to the VCR controller 340 can be transferred to the DVD controller 240, and the DVD controller 240 can also transfer commands to the VCR controller 340.

As above, the controller of the DVDP/VCR combo-system 400 is constructed with the VCR controller 340, VCR communication part 330, DVD controller 240, and DVD communication part 330, of which the VCR communication part 330 and the DVD communication part 230 together provide a communication part for enabling communications between the VCR device 300 and the DVD device 200.

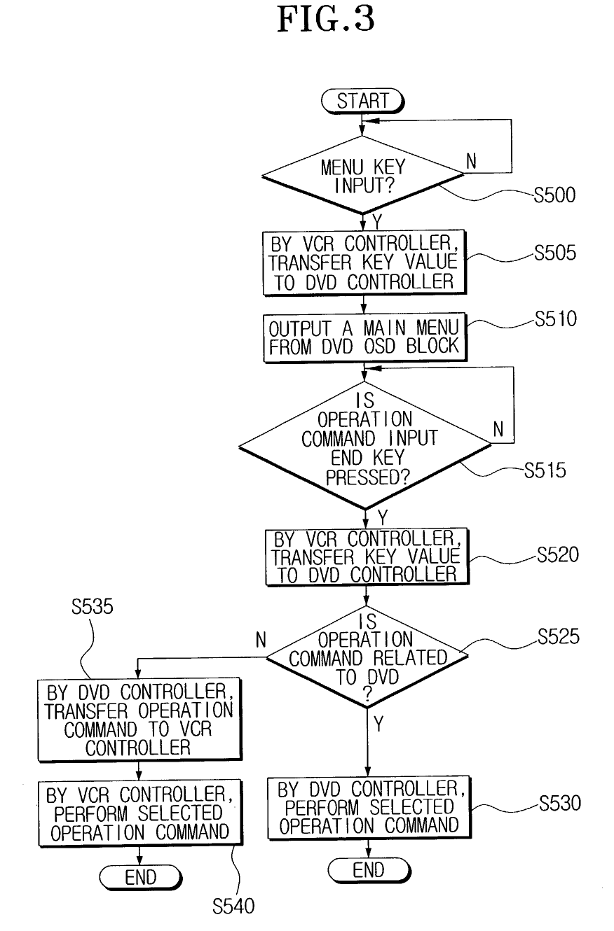

FIG. 3 is a flow chart for showing an operation control process of a combination system according to an embodiment of the present invention.

If a user presses a menu key set to choose a main menu through a separate input device such as the remote controller 350, the key input part 312 provided on the DVDP/VCR combo-system, or the like (S500), the VCR controller 340 operates as an input controller to receive a key value. The VCR controller 340 transfers the received key value to the VCR communication part 330 and the DVD controller 240 through the DVD communication part (S505).

The DVD controller 230 interprets the received key value and, accordingly, transfers to the DVD OSD block 220 a command for outputting an OSD screen. The DVD OSD block 220, having received the command, outputs a main menu of an OSD (S510). Thus, the DVD controller 230 operates as a command controller interpreting the inputted key value, and commanding the DVD OSD block 220 to output the OSD screen. For example, the main menu of the OSD is displayed on the screen of a TV set or the like connected to the DVDP/VCR combo-system 400.

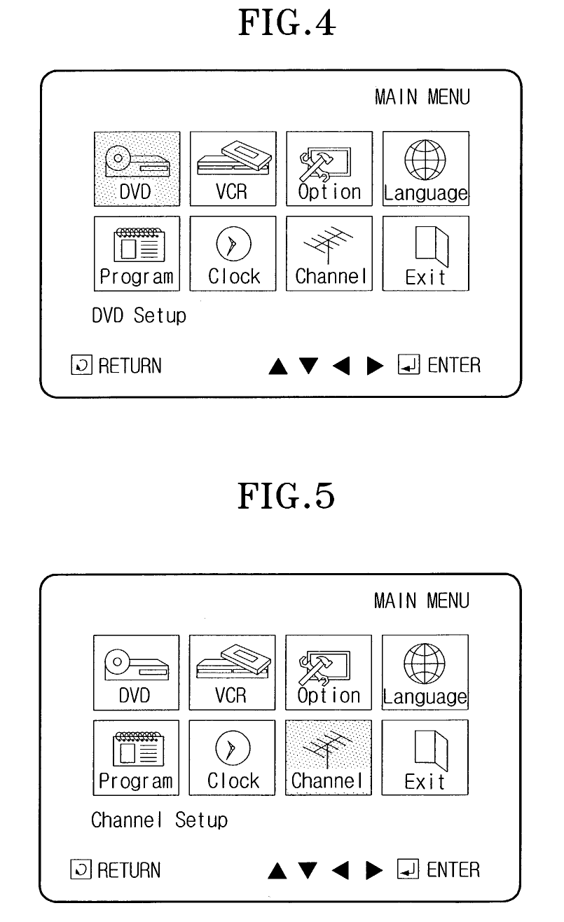

FIG. 4 shows an illustration of a main menu appearing on an OSD. In FIG. 4, the main menu of the OSD comprises such items as ‘DVD’, ‘VCR’, ‘Option’, ‘Language’, ‘Program’, ‘Clock’, ‘Channel’, and ‘Exit’. A user can use the remote controller 350, the key input part 312, or the like to choose one of the items. FIG. 4 shows the selection of the item ‘DVD’ from the main menu of OSD display, and FIG. 5 shows the selection of the item ‘Channel’.

Even though not shown, each item can be configured to have a sub-menu. For example, the ‘DVD’ item can have a sub-menu for environment settings of the DVD device 200. For example, if a user selects the item ‘DVD’, a sub-menu is displayed for the environment settings of the DVD device 200, which includes items such as ‘TV Aspect Ratio’, ‘Language’, ‘Still Mode’, ‘Black Level’, ‘Alt Video Out’, and so on. Likewise, the item ‘Clock’ can have a sub-menu display including items such as ‘Auto Clock Set’ for automatic time settings, ‘Manual Clock Set’ for manual time settings, and so on. The item ‘Language’ for language settings can have a submenu display including items such as ‘English’, ‘French’, ‘Spanish’, and the like, for selecting language to be used on the OSD.

As described above, a user sequentially proceeds with selections from the items provided on a main menu display and one or more sub-menu displays so that he or she can choose a desired operation command via the OSD.

If a user makes an operation command choice through looking up a main menu display and a sub-menu display and presses a key predetermined as an operation command input end key such as the enter key or the like (S520), the VCR controller 340 recognizes the key press and transfers a received key value to the DVD controller 240 (S525).

The DVD controller 240 interprets the inputted key value and decides what the corresponding operation command corresponds to. If the inputted operation command is an operation command related to the DVD as a result of the decision (S525), the DVD controller 240 performs an operation based on the corresponding operation command (S530).

If the inputted operation command is not an operation command related to the DVD, the DVD controller 240 transfers the operation command to the VCR controller 340 through the DVD communication part 230 and the VCR communication part 330 (S535). The VCR controller 340, in turn, carries out the received operation command (S540). By such a process as described above, a user can control the DVD device 200 and the VCR device 300 by using one main OSD.

In the above embodiment, the VCR controller 340 receives and transfers to the DVD controller 240 an operation command that a user inputs with the look-up of the OSD display, and the DVD controller 240 interprets the transferred command and controls the DVD OSD block 220. This is because the VCR controller 340 is used as a main controller in a combination system into which a DVD player and a VCR are combined, but the OSD block in the DVD player has a higher quality and more diverse functions, so that it is preferable for the DVD controller 240 to control the OSD display.

However, it is possible to construct a different embodiment from the above by arbitrarily selecting a device for receiving an operation command that a user inputs with the look-up of the OSD or a device for interpreting the operation command and controlling the OSD.

With the present invention, it is possible that a list of operation commands used in plural devices through one OSD is displayed and an internal controller transfers to a corresponding device an operation command that a user inputs with the look-up of the OSD in order for the corresponding device to perform the operation command. Accordingly, a user can conveniently manipulate respective devices in a combination system with a single OSD.

Further, although a preferred embodiment of the present invention has been described, it will be understood by those skilled in the art that the present invention should not be limited to the described preferred embodiment, but various changes and modifications can be made within the spirit and scope of the present invention as defined by the appended claims, and such changes and modifications should not be individually understood from the technical thought and outlook of the present invention.

What is claimed is:

1. A control apparatus for use in a combination system having plural devices for performing independent functions in response to operation commands, the control apparatus comprising:
an on-screen display (OSD) module for outputting an OSD that displays a list of operation commands that can be inputted for controlling operations of each of the plural devices; and
a controller for receiving an input from a user input device in response to selection of one of said operation commands, interpreting said input to determine which of said operation commands has been selected via said input, and to which of the plural devices said operation command is to be transferred, and transferring the said operation command to the corresponding one of the plural devices to perform the operation command.

2. A control apparatus as claimed in claim 1, wherein said controller comprises:
an input controller for receiving said input;
a command controller for interpreting said input and transferring the corresponding said operation command to the corresponding one of the plural devices to perform said operation command; and
a communication part for enabling communications between said input controller and said command controller and between said command controller and each of the plural devices.

3. A control apparatus as claimed in claim 2, wherein said user input device is one of a remote control device and a key input device, said input comprising a key value corresponding to one of said operation commands.

4. A control apparatus as claimed in claim 2, wherein said input is a request for a main menu, said command controller being programmable to send a command to said OSD module to generate a main menu screen for display.

5. A control apparatus as claimed in claim 2, wherein the plural devices include a digital video disk or DVD player for reproducing a signal recorded on a DVD, and a video cassette recorder or VCR for recording and reproducing a signal to and from a magnetic tape, said DVD player comprising said OSD module and said command controller, and said VCR comprising said input controller.

6. A control apparatus as claimed in claim 5, wherein said DVD player comprises a DVD communication part and a DVD controller connected to said DVD communication part and said OSD module and said VCR comprises a VCR communication part and a VCR controller connected to said VCR communication part, said command controller being said DVD controller, said input controller being said VCR controller, and said communication part comprising said VCR communication part and said DVD communication part which are each configured to communicate to each other and to transfer said operation commands to each other.

7. A control apparatus as claimed in claim 5, wherein said input is a request for a main menu, said command controller being programmable to send a command to said OSD module to generate a main menu screen for display.

8. A control apparatus as claimed in claim 7, wherein a display device is connected to at least one of said DVD player and said VCR and said OSD module is programmable to send said main menu screen to said display device.

9. A control apparatus as claimed in claim 7, wherein said main menu screen comprises the options of ‘DVD’ and ‘VCR’, said OSD module being operable to generate, respectively, a DVD sub-menu and a VCR sub-menu in response to a user selecting a corresponding one of said options of ‘DVD’ and ‘VCR’, said DVD submenu and said VCR sub-menu each comprising options for controlling said DVD player and said VCR.

10. A control apparatus as claimed in claim 9, wherein said main menu screen comprises at least one additional option selected from the group consisting of ‘Option’, ‘Language’, ‘Program’, ‘Clock’, ‘Channel’, and ‘Exit’.

11. A control apparatus as claimed in claim 6, wherein said input corresponds to an operation command for one of a DVD player function and a VCR function, said DVD controller being programmable to perform said DVD function if said input corresponds to an operation command for a DVD player function, and to transfer said operation command to said VCR via said communication part if said input corresponds to an operation command for a VCR function.

12. A method for controlling a combination system having plural devices for performing independent functions in response to operation commands, the method comprising the steps of:
generating an OSD to display a list of operation commands that can be inputted for selectively operating each of the plural devices;
receiving an input from a user input device corresponding to one of said operation commands; and
interpreting and transferring said received operation command to a corresponding one of the plural devices to perform said received operation command.

13. A method as claimed in claim 12, wherein the plural devices include a digital video disk or DVD player for reproducing a signal recorded on a DVD, and a video cassette recorder or VCR for recording and reproducing a signal to and from a magnetic tape, said receiving step is performed via said VCR, said generating step and said interpreting step are performed via said DVD player.

14. A method as claimed in claim 13, further comprising the step of transferring said operation commands relating to said VCR from said DVD player to said VCR.

15. A method as claimed in claim 12, wherein the plural devices include a digital video disk or DVD player for reproducing a signal recorded on a DVD, and a video cassette recorder or VCR for recording and reproducing a signal to and from a magnetic tape, and further comprising the step of controlling all of the operations of said VCR and said DVD player through a single said OSD to obviate a user having to change between a DVD operation mode and a VCR operation mode.
